(19) United States
(12) Patent Application Publication
(10) Pub. No.: US 2006/0245731 A1
(43) Pub. Date: Nov. 2, 2006

(54) Digital network video recorder and the monitoring system thereof

(76) Inventor: Chih-Chuan Lai, Jhonghe City (TW)

Correspondence Address: J C PATENTS, INC., 4 VENTURE, SUITE 250, IRVINE, CA, 92618, US

(21) Appl. No.: 11/233,626

(22) Filed: Sep. 22, 2005

(30) Foreign Application Priority Data
Apr. 27, 2005 (TW) 94113393

(51) Int. Cl. H04N 7/00

(52) U.S. Cl. 386/96

(57) ABSTRACT

A digital network video recorder (NVR) and a monitoring system thereof are provided. The NVR features low cost and high stability and is easy to install and use. The NVR receives video/audio data from a network and provides functions of such as the real-time monitoring, recording, and searching/playback operations. The NVR comprises a network module, a storage module, an input/output module and a control module. The network module serves as an interface between the NVR and the network. The storage module stores the video/audio data received from the network and provides the stored video/audio data. The input/output module receives instructions from a user and provides a video playback operation. The control module controls the reception, storage, searching, and playback of the video/audio data.

### CROSS-REFERENCE TO RELATED APPLICATION

This application claims the priority benefit of Taiwan application serial no. 94113393, filed on Apr. 24, 2005. All disclosure of the Taiwan application is incorporated herein by reference.

### BACKGROUND OF THE INVENTION

1. Field of the Invention

The present invention relates to a digital network video recorder and a monitoring system thereof. In particular, the present invention relates to a fully digital network video recorder and a monitoring system thereof for directly receiving digital video/audio data using the internet, wired LAN, and wireless LAN.

2. Description of the Related Art

In the past, for the sake of compatibility with analog video recorder, a signal input terminal of a conventional digital video recorder (DVR) is a BNC connector for receiving analog siganls. The signals go through the DVR's internal processing to become digital signals stored on a hard disk. this type of device has certain limitations during use. First, the DVR must directly connect to the video cameras by cables; thus there are creating cable distribution problems. For example, a high-rise building installed with ten video cameras would require ten cables. The cable length and installation locations all are cable distribution engineering issues needing to be addressed. At the same time, the DVR has to be provided with the ten connectors; otherwise, there needs to be several DVRs operating concurrently. In addition, the DVR and the video cameras have to be in close proximity, such as in the same room, because of concerns for important monitored data to be damaged by thieves and intruders.

Currently the internet is very widespread, and using the internet for monitoring is a common solution. However, conventional internet apparatuses have numerous shortcomings. A typical network-attached storage (NAS) is only suitable for use as a storage device, and not for use as the monitoring purposes because it does not support a real-time monitoring and playback function. In regard to Personal Computer (PC)-based software solutions, they not only have high hardware and software costs, but are also limited by operating system stability. The conventional PC operating system is all designed for general purposes. For example, Microsoft Windows® operating systems, even though are very widespread, have danger of crashing, and thus cannot provide for the stringent requirement for system stability for monitoring systems. Another example, Linux® and FreeBSD®, although both are more stable, are not widespread and have limited software developed for these platforms. since a typical user is not familiar with the installation, setup, and management of these systems, thus requiring to hire dedicated professional managers of information system, which is not cost effective.

Based on the aforementioned, in the future vision of a digital world, fulfilling the need for internet monitoring requirements, there requires to have specialized designs for surveillance management which can also provide fully digital monitoring storage equipment solution packages for solving the above issues.

### SUMMARY OF THE INVENTION

According to the foregoing description, an object of the present invention is to provide a DVR capable of using the internet for directly input/output of digital video/audio signals to achieve fully digital and network monitoring system.

The present invention's other objective is to provide a digital network surveillance management system combining the wireless local area network's elimination of cable distribution and convenience and extensibility of cable LAN and internet to allow the user using the internet system to remotely provide real-time surveillance management for the surveillance target.

To meet the above objectives, the present invention presents a type of digital network video recorder including a network module, storage module, input/output module, and control module. Wherein the network module is providing the communication interface between the digital network video recorder and the network. The storage module is for storing the video/audio feed from the network and can also used for providing pre-installed video/audio data. The input/output module is for receiving user commands and outputting of the video/audio signal to the external display devices and speakers; it is the communication interface between the digital network video recorder and the user. Control module is between the aforementioned network module, storage module, and input/output module; it is controlling the reception, storage, searching, and playback functions for the video/audio data.

In the aforementioned digital video recorder for an embodiment, the network module also comprises network interface, LAN network interface card, and wireless LAN interface. The aforementioned network interface connects to the aforementioned control module, separately becoming the interface between the aforementioned digital video recorder and the internet, wired LAN, and wireless LAN.

In the aforementioned digital video recorder in an embodiment, the aforementioned control module also comprises network server unit, user interface unit, video display and decryption unit, and video recorder unit. The network server unit couples the network module, using network packets to capture the video feed, managing the network traffic flow, receiving warning notification, and providing Internet Protocol (IP) address allocation mechanism. The user interface unit couples to the input/output module, providing command selection for the user. The video display and decryption unit is in charge of decryption of the video data to becoming video and audio signals, and providing the aforementioned video and audio signal to the input/output module. Finally, the digital video recorder unit, coupling between the network server unit, the user interface, the video display and decryption unit, and the storage module, is controlling the real-time surveillance management, recording, playback, and search of the video/audio data.

In the aforementioned DVR in an embodiment, the received warning notification for the network server unit is from the network video recorder.

In the aforementioned digital network video recorder in an embodiment, the aforementioned warning notification is triggered by the externally-connected sensor or motion detection of the network camera.

From another perspective, the present invention also presents a digital network surveillance management system, including network camera and digital network video recorder. The network camera provides the video feed. The digital network video recorder is using the network for receiving the video/audio signal, and providing for the real-time surveillance management, storage, search, and playback of the video/audio signal.

In the aforementioned digital network surveillance management system in an embodiment, the aforementioned digital network camera can be located at the internet, the wired LAN, or the wireless LAN.

In the aforementioned digital network surveillance management system in one embodiment, the aforementioned digital network video recorder can direct towards the user to provide the user interface for supporting surveillance management needs; the aforementioned user can be located at the native or distance end. For example, communicating with the digital network video recorder through the internet, wired LAN, or wireless LAN.

The present invention's digital network video recorder is using specialized hardware and software designed for surveillance management systems. Therefore, it is not affected by the hardware infrastructure of personal computers and their operating systems limitations; it has lower cost, improved stability, and installation & ease of operation advantages.

The present invention's digital network video recorder's receiving terminal is a RJ-45 connector, which can directly use the network cable for receiving the digital data, and only requiring a single network cable to simultaneously receiving a multitude of network camera video feed and data, greatly simplifying the installed surveillance system's cable distribution issues. Because the network can be extended in great distances, therefore, the stored media can be installed at the distance end, separated from the video camera, without fear of outsider intrusion or valuable surveillance data from leakage or damage.

The digital network video recorder in the present invention simultaneously possesses a variety of network interfaces, combining the convenience of the wireless local area network by eliminating cable distribution needs and the extensibility of wired LAN and internet for receiving video/audio data from the aforementioned variety of network received video/audio data. In addition, the user interface unit and the web host server are used for providing the command selection, and the input device and web host server are used for receiving the user's commands. Therefore, it allows the user to directly operate from either the native or distance end using internet, wired LAN, or wireless LAN for real-time monitoring of video/audio data or for temporary storage of video/audio information in the storage media awaiting search and playback. Furthermore, the network server unit in the digital video recorder for the present invention can also receive warning notifications from the network camera to provide warning to the user.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings.

FIG. 1 is a configuration block diagram showing a digital network video recorder according to an embodiment of the present invention.

FIG. 2 is a schematic diagram showing a digital network surveillance management system according to an embodiment of the present invention.

### DESCRIPTION OF THE EMBODIMENTS

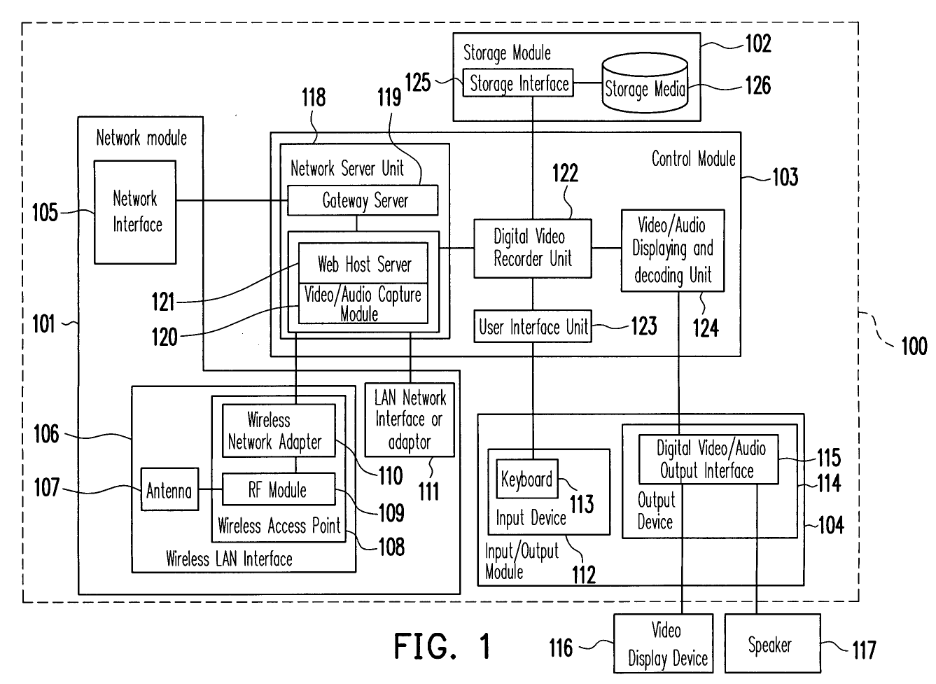

FIG. 1 shows components and their connections according to a digital network video recorder 100 of the present invention. Simply speaking, the digital network video recorder 100 in FIG. 1 can receive video/audio data and other digital signals sent from the network camera, such as warning notification or setting up change signal, through the internet, wired LAN, and wireless LAN. The user can operate the digital network video recorder 100 at the local end, or use the aforementioned three network systems to establish a remote connection for real-time monitoring, storing video/audio data (recording), or searching/playing the stored data (playback).

The digital network video recorder 100 comprises a network module 101, a storage module 102, an input/output module 104, and a control module 103. The network module 101 is an interface between the digital network video recorder 100 and the network. The storage module 102 is used for storing the video/audio data from the network, and also for providing the stored video/audio data. The input/output module 104 is used for receiving user's command or for outputting the video/audio signal to the external video display devices and speakers, and provides a communication interface between the digital network video recorder 100 and the user. The control module 103 is coupled among the network module 101, the storage module 102 and the input/output module 104 for controlling the reception, storage and search/playback of the video/audio data.

In the present embodiment, the network module 101 comprises an internet interface 105, a LAN network interface card 111 and a wireless LAN interface 106, or any one or two of the aforementioned three interfaces, depending upon the market target the application requirement of the products. To thoroughly describe the present invention, the network module 101 simultaneously comprises the three types of interfaces 105, 106, 111 as a preferred embodiment of the present invention. The aforementioned internet interface 105, the wireless LAN interface 106, and the LAN network interface card 111 respectively serve as communication interfaces between the digital network video recorder 100 and the different network systems. The so-called network systems include the internet, the wired LAN, the wireless LAN, and others. The internet interface 105 is coupled to a gateway server 119. The gateway server 119, the LAN network interface card 111 and the wireless LAN interface 106 are coupled to a web host server 121 and a video/audio capturing module 120.

The aforementioned wireless LAN interface 106 comprises a wireless access point 108 and an antenna 107. The wireless access point 108 further comprises a wireless network adapter 110 and a RF (Radio Frequency) module 109. When the control module 103 requires to send out the digital data, the wireless network adapter 110 first receives the digital data, converts the digital data into digital signals, and then outputs the digital signals to the RF module 109. Thereafter, the RF Module 109 converts the digital signals into the RF signals, and then transmits to the antenna 107 for transmitting the RF signals to the wireless LAN. In contrast, when the antenna 107 receives the RF signals, the aforementioned process is reversed: first, the antenna 107 transmits the RF signals to the RF module 109, the RF module 109 converts the RF signals into digital data, and then the digital data is provided to the control module 103.

As shown in FIG. 1, the storage module 102 comprises a storage media 126 and a storage interface 125. The storage media 126 is responsible for actually storing and reading the video/audio data. The storage interface 125 serves as a communication interface between a digital video recorder unit 122 and the storage media 126. In the present embodiment, the storage media 126 can be a disk drive or memory card, for example, various types of hard disks, CF card, SD Card, Memory Stick [symbol] Memory Stick Pro [symbol] Memory Stick Duo [symbol] XD card [symbol] Mini XD [symbol] Smart Media, etc., or any combinations of the aforementioned storage devices or other similar types of storage devices. It should be noted that although the storage media 126 is an important part for the present embodiment of digital network video recorder 100 operations, the storage media 126 can be easily obtained because of the maturity for storage media technology. Therefore, according to requirement, the present invention can be operated without haing the storage media 126, but instead only provides the storage interface 125 to allow the users themselves to select the storage media 126.

The input/output module 104 in FIG. 1 comprises an input device 112 and an output device 114. The input device 112 is coupled to the user interface unit 123, for receiving commands from the user by using a keyboard 113 of the input device 112. The output device 114 is coupled to a video/audio displaying and decoding unit 124. Through a video/audio output interface 115, the output device 114 can receive video and audio signals that are decoded by the digital display and decoding unit 124. The received video and audio signals are respectively output to an external video display device 116 (for example, a computer monitor or TV monitor) and a speaker 117. Generally speaking, the video display device 116 and the speaker 117 are easily obtainable devices. For the sake of superiority in light weight and low cost for the digital network video recorder 100 of the present embodiment, the externally-connected video display device 116 and the speaker 117 are selected instead of the built-in types. If necessary, the present invention can also use built-in video display device and speaker.

In FIG. 1, the control module 103 comprises a network server unit 118, the user interface unit 123, the video/audio displaying and decoding unit 124, and the video recorder unit 122. The network server unit 118 is coupled to the internet interface 105, the wireless LAN interface 106, the LAN network interface card 111, and the video recorder unit 122. The functions of the network server unit 118 include acquiring video/audio data from network packets, controlling the network traffic flow, receiving control signals set by a remote user, receiving warning notifications from the network camera, allocating IP addresses to the network camera. The aforementioned warning notifications can be received from an external sensor for the network camera, triggered by a motion detection, or other warning types.

The aforementioned user interface unit 123 is coupled between the input device 112 and the video recorder unit 122, for providing a command selection for a user at the local terminal. The video display and decoding unit 124 decodes the video/audio data output from the video recorder unit 122 into the video signal and audio signals, and then provide the video signal and audio signals to the video/audio output interface 115. The video recorder unit 122 is coupled between the network server unit 118, the user interface unit 123, the video/audio displaying and decoding unit 124, and the storage media interface 125 in order to control the real-time monitoring, recording, playback, and searching operations for the video/audio data. In addition, the real-time monitoring, recording, playback, and searching functions, etc. are well developed for the video/audio data. Even though the implementation details for various companies are different from each other, these technologies are familiar for those skilled in this art, and thus no redundant descriptions are made here. In the present embodiment, regarding the search function for the video recorder unit 122, recording time and date, time point of occurrences of the warnings or other criteria can be used for searching the video/audio data.

The network server unit 118 in FIG. 1 comprises the gateway server 119, the webpage server 121, and a video/audio capturing module 120. The gateway server 119 is coupled to the network interface 105, the webpage server 121 and the video/audio capturing module 120, providing an IP address redirect service required for connecting to the network, for example, a network address translation (NAT). The gateway server 119 also functions as a firewall for providing control and protection of the network traffic.

In network server unit 118, the webpage server 121 is coupled between the wireless LAN interface 106, the LAN network interface card 111, the gateway server 119 and the video recorder unit 122, providing a user interface required by the remote control for users of the above three types of network. The video/audio capturing module 120 similarly couples between the wireless LAN interface 106, the LAN network interface card 111, the gateway server 119, and the video recorder unit 122.

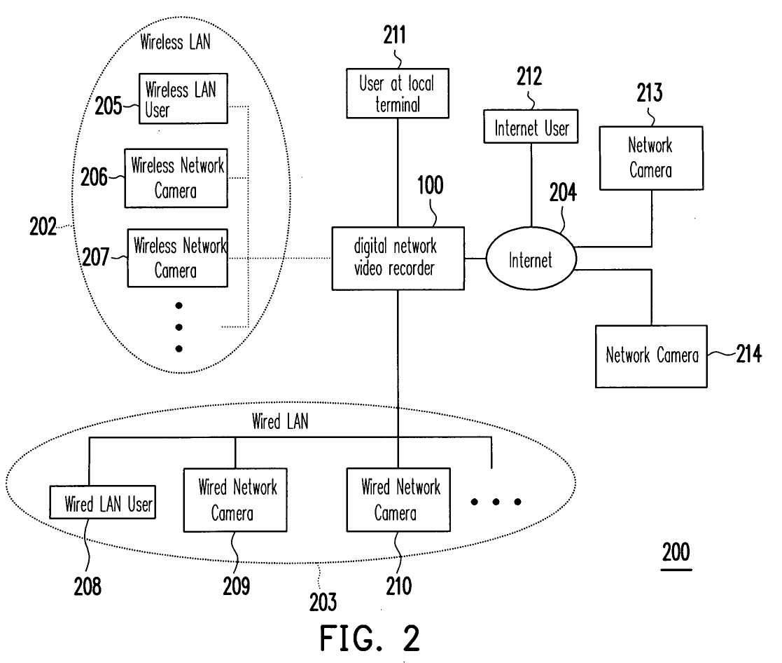

In another embodiment of the present invention as shown in FIG. 2, the digital network video recorder 100 in FIG. 1 is used to construct a digital network monitoring system 200. The digital network monitoring system 200 comprises at least one digital network video record 100 and a plurality of network cameras. In FIG. 2, the network cameras can be wireless network cameras 206-207, wired network cameras 209-210, and network cameras 213-214. The network cameras 213, 204 disposed on the internet 204 can be either wired or wireless. Therefore, the digital network video recorder 100 can use the network to receive video/audio data provided from the aforementioned network cameras 206-207, 209-210 and 213-214, and can further at the same time provide user interfaces to uses 211 of the local terminals, users 205 of the wireless LAN 202, users 208 of wired LAN 203, users 212 of the internet 204, so as to achieve the real-time monitor, storage, search, and playback functions for the video/audio data. In the present invention, both hardware and software of the digital recorder/player are dedicated for the monitoring system. Therefore, the hardware and the software are not limited by the conventional personal computer hardware configuration and its operating system. As a result, the present invention is advantageous in lower cost, better stability and ease operation and installation. In the digital network video recorder of the present invention, receiving ends of the wired network area and the internet are RJ-45 connectors capable of directly receiving digital video/audio data through the network wire. Through one single network wire, video/audio data of a plurality of network cameras can be received at the same time. Therefore, the wire arrangement issue for installing the monitoring system can be significantly simplified. Since the network can be far extended, the storage media can be set at remote locations and separated from the cameras, or even can be distributed in different countries, without fear of leaking or losing valuable monitoring data due to unauthorized intruders.

In summary, the digital network video recorder of the present invention can possess simultaneously many network interfaces, combining the convenience of no wiring requirement for the wireless network and the extensibility for the wired LAN and internet. The digital network video recorder can receive the video/audio data from a variety of networks mentioned above. In addition, the digital network video recorder uses the user interface unit and the webpage server to provide command selections, and also uses the input device and the webpage server to receive command from the user. Therefore, from the direct operation at the local terminal, the internet, the wired LAN, or the wireless LAN, the user can monitor the video/audio data in real time, or store the video/audio data temporally for search or playing later. Furthermore, according to the digital network video record of the present invention, the network server unit can also receive the warning notifications sent from the network cameras, and thus provides warning to the user.

Although the present invention has been described in terms of exemplary embodiments, it is not limited thereto. Rather, the appended claims should be constructed broadly to comprise other variants and embodiments of the invention which may be made by those skilled in the field of this art without departing from the scope and range of equivalents of the invention. Therefore, the protection region should be based on boundaries defined by the appended claims as the basis.

What is claimed is:

1. A digital network video recorder, for receiving and storing digital video/audio data from a network, comprising:
a network module, being an interface between the digital network recorder and at least one network system;
a storage module, for storing the digital video/audio data from the network, and providing the stored digital video/audio data;
an input/output module, receiving at least one user command and providing a video playback operation; and
a control module, coupled among the network module, the storage module and the input/output module, automatically through the network module sending a request for video/audio data to at least one network camera in the network, and recombining a plurality of network packets sent from the at least one network camera to obtain the digital video/audio data, and then controlling reception, storage, search, and playback of the digital video/audio data.

2. The digital network video recorder of claim 1, wherein the network module at least comprises one of an internet interface, an LAN network interface card and a wireless LAN interface, wherein the internet interface, the LAN network interface card and the wireless LAN interface are coupled to the control module to respectively serve as an interface to connect the digital network video recorder with the internet, the wired LAN and the wireless LAN.

3. The digital network video recorder of claim 2, wherein the wireless LAN interface further comprises:
an antenna, transmitting and receiving a radio-frequency signal; and
a wireless access point, for converting the digital video/audio data into sent by the control module into the RF signal and then providing to the antenna, or for converting the RF signal received by the antenna into the digital data and then providing to the control module.

4. The digital network video recorder of claim 3, wherein the wireless access point further comprises:
a RF module, for converting a first digital signal into the RF signal and then providing to the antenna, or for converting the RF signal received from the antenna into a second digital signal; and
a wireless network adapter, for the digital signal sent from the control module into the first digital signal and then providing to the RF module, or for converting the second digital signal into the digital video/audio data and then providing to the control module.

5. The digital network video recorder of claim 1, wherein the storage module further comprises:
a storage media, storing the digital video/audio data obtained from the network, and providing the stored digital video/audio data;
a storage interface coupled between the control module and the storage media, for establishing a communication between the control module and the storage media.

6. The digital network video recorder of claim 5, wherein the storage media is selected from a group consisting of at least one disk drive and at least one memory card.

7. The digital network video recorder of claim 1, wherein the input/output module further comprises:
an input device, coupled to the control module, for receiving at least one user command; and
an output device, coupled to the control module, for providing a video/audio playback operation.

8. The digital network video recorder of claim 7, wherein the input device comprises a keyboard for receiving at least one user command.

9. The digital network video recorder of claim 7, wherein the output device further comprises:
an video/audio output interface coupled to the control module, for receiving a video signal and an audio signal decoded from the digital video/audio data, and then outputting the video signal outputting to a video display device, and outputting the audio signal to a speaker.

10. The digital network video recorder of claim 1, wherein the control module further comprises:
a network server unit coupled to the network module, for acquiring the digital video/audio data from network packets, controlling a network traffic flow, receiving control signals set by a remote user, receiving warning notifications, and providing an IP address allocation mechanism;
a user interface unit coupled to the input/output module, for providing a command selection to at least one user;
a video/audio displaying and decoding unit, for decoding the digital video/audio data into a video signal and an audio signal, and providing the video signal and the audio signal to the input/output module; and
a video recorder unit coupled among the network server unit, the user interface unit, the video/audio displaying and decoding unit, and the storage module, for controlling the real-time monitoring, recording, playback, and searching of the digital video/audio data.

11. The digital network video recorder of claim 10, wherein the warning notification received by the network server unit is triggered by a dynamic detection function of the at least one network camera.

12. The digital network video recorder of claim 10, wherein the warning notification received by the network server unit is from at least one external sensor of the at least one network camera.

13. The digital network video recorder of claim 10, wherein the IP address allocation mechanism of the network server unit is used for allocating an IP addresses to the at least one network camera.

14. The digital network video recorder of claim 10, wherein the video recorder unit searches the digital video/audio data according to at least one of recording time and date, and time points of occurrences of the warning notifications.

15. The digital network video recorder of claim 10, wherein the network server unit further comprises:
a gateway server coupled to the network module, for providing an IP address redirect service required by the internet;
a webpage server coupled between the gateway server and the video recorder unit, for providing an user interface for a remote monitoring operation; and
a video/audio capturing module coupled between the gateway server and the video recorder unit, for actively sending a request for the digital video/audio data through the network module to the at least one network camera, and for recombining the network packets returned by the at least one network camera to obtain the digital video/audio data.

16. A digital network monitoring system, comprising:
at least one network camera, providing at least one digital video/audio data; and
at least one digital network video recorder, for receiving the at least one digital video/audio data through a network, and for providing a real-time monitoring, storing or searching and playback operation for the at least one digital video/audio data.

17. The digital network monitoring system of claim 16, wherein the at least one digital network video recorder further comprises:
a network module, for serving as an interface between the at least one digital network video recorder and the at least one network camera;
a storage module, for storing and providing the at least one video/audio data;
an input/output module, for receiving at least one user command and providing a video/audio playback operation;
a control module coupled among the network module, the storage module, and the input/output module, for actively sending a request for the digital video/audio data through the network module to the at least one network camera, and for recombining the network packets returned by the at least one network camera to obtain the digital video/audio data, and then controlling a reception, storage, or search and playback operation of the at least one digital video/audio data.

18. The digital network monitoring system of claim 16, wherein the at least one network camera is disposed at one of an internet, a wired LAN and a wireless LAN.

19. The digital network monitoring system of claim 16, wherein the at least one digital network recorder/player is able to provide a user interface to at least one user for monitoring, and the at least one user is located at one of a local terminal, an internet, a wired LAN and a wireless LAN.
